(19) United States
(12) Patent Application Publication
(10) Pub. No.: US 2023/0216855 A1
(43) Pub. Date: Jul. 6, 2023

(54) Air-Gapped Remote Controller System

(71) Applicant: Roman Potapov, Cary, NC (US)

(72) Inventor: Roman Potapov, Cary, NC (US)

(21) Appl. No.: 18/182,040

(22) Filed: Mar. 10, 2023

Related U.S. Application Data
(63) Continuation-in-part of application No. PCT/US22/40487, filed on Aug. 16, 2022.
(60) Provisional application No. 63/233,913, filed on Aug. 17, 2021.

(51) Int. Cl. H04L 9/40

(52) U.S. Cl. CPC H04L 63/10

(57) ABSTRACT

The air-gapped device controller system provides a disconnected (air-gapped) remote endpoint controller that does not allow any programmatic manipulation of the remote system and works exclusively on an analog basis. To accomplish this, the system includes an apparatus that is connected to the end-user via internes or any other network and interacts with an air-gapped system (remote system) physically. It does so by translating the user's physical input to a signal on the wire and then recreating the user's physical input on the interface attached to the air-gapped system (e.g., pressing buttons, operating a touch pad or a mouse, user's video feed etc. Further, the system provides a method to allow the user to control an air gap control system without physically operating the hardware of the air gap control system. Additionally, the system may operate and control operating systems, computers, cameras, microphones, display systems, etc.

### FIELD OF THE INVENTION

The present invention relates to computer equipment and security, including a controller that requires neither wired nor emanated connection between the controlling system and the controlled system to ensure that a secure computer network is physically isolated from unsecured networks

### BACKGROUND OF THE INVENTION

Nearly every company in existence keeps some sort of information confidential when it comes to sensitive intel and information. Whether the information is for security reasons or simple privacy, it is important that such information is kept confidential. Within a professional work environment, it is important to keep information, material, hardware, etc. confidential to a specific location to reduce the chances of unwanted exposure. For example, well-known industries such as NASA encourage employees to work physically on-site. This reduces the exposure chances of hardware and information from leaking and exposing to the public. The forementioned situation is one of many circumstances in which can be an inconvenience as working from home is a preferred option for some people.

New research from WatchGuard has found that malware is increasingly targeting endpoints more than perimeter (WatchGuard Q3 Report). According to a 2020 Ponemon/Morphisec Study, 68% of organizations have experienced one or more endpoint attacks over the last two years. Reports also indicate that anti-virus/anti-malware solutions miss an average of 60 percent of attacks! Of the attacks that resulted in a compromised endpoint, 80% were characterized as a zero-day threats (for which signature-based antivirus/antimalware is ineffective), but 17% say the threat was known, and 3% are unsure.

As is known, there is a wide variety of different types of endpoint protection systems are available for businesses to use. They work based on a number of different principles with varying degree of success and they are very expensive on an enterprise level. However, there are many downfalls with the current endpoint security systems used for these purposes. For example, almost none of them can protect from an insider attack by a disgruntled administrator-level employee. In another example, zero-day (never seen before) malware and attacks are almost always missed by the endpoint protection systems, because most of them work on a precedent or statistical basis. Using artificial intelligence to generate defensive techniques is also problematic because of a great variance in attack paths and lack of uniform datasets representing complete stages of cybersecurity incidents. Accordingly, there is still a need for a definitive endpoint protection system, that would become extremely useful and simple to use. The system should also work right out of the box and be compatible with any enterprise and other computer systems from various manufacturers.

Existing air-gapped systems transfer signal through the air gap via emanations of various wavelengths, like sound, infrared, light, that work like an information and command transmission medium. Each of those systems may still transmit a malicious code or a command to elevate the endpoint's privileges via the medium. Unlike those systems, our proposed System does not emit any programmatic signal and only permits a physical interaction that simulates human behavior at a terminal. In other words, no code can be uploaded from the endpoint to the remote system. Any internet-connected device can serve as an endpoint even when infected locally. If an upload to the remote host is needed it may be initiated by the endpoint but completed via a separate super secure gateway or a separate disconnected internal repository instead of the endpoint itself.

An Air-gapped system is a system that can only be controlled physically. Air-gapped systems are computers, terminals and other interfaces that are not connected to the internet or any other network outside of their immediate network. Air-gapped systems are required when the highest level of security is required to prevent threats from malicious actors via malware delivered through a network.

An objective of the present invention is to provide an air-gapped system controller. According to a preferred embodiment, the present invention provides a disconnected (air-gapped) remote endpoint controller that does not allow any programmatic manipulation of the remote system and works exclusively on an analog basis. In other words, the present invention provides a system that allows the user to control an air gapped control system without physically operating the hardware of the air gap control system. To accomplish this, the present invention comprises an apparatus that is connected to the end-user via internet or any other network and interacts with an air-gapped system (remote system) physically. It does so by translating the user's physical input to a signal on the wire and then recreating the user's physical input on the interface attached to the air-gapped system (e.g., pressing buttons, operating a touch pad or a mouse, user's video feed etc. Further, the present invention provides a method to allow the user to control an air gap control system without physically operating the hardware of the air gap control system. Additionally, the present invention can operate and control operating systems, computers, cameras, microphones, display systems, etc.

### SUMMARY

The present invention provides a disconnected (air-gapped) remote endpoint controller that does not allow any programmatic manipulation of the remote system and works exclusively on an analog basis. In other words, the present invention provides a system that allows the user to control an air gapped control system without physically operating the hardware of the air gap control system. To accomplish this, the present invention comprises an apparatus that is connected to the end-user via internet or any other network and interacts with an air-gapped system (remote system) physically. It does so by translating the user's physical input to a signal on the wire and then recreating the user's physical input on the interface attached to the air-gapped system (e.g., pressing buttons, operating a touch pad or a mouse, user's video feed etc. Further, the present invention provides a method to allow the user to control an air gap control system without physically operating the hardware of the air gap control system. Additionally, the present invention can operate and control operating systems, computers, cameras, microphones, display systems, etc.

### BRIEF DESCRIPTION OF THE DRAWINGS

FIG. 1 is a schematic representation of the present invention, according to a preferred embodiment of the present invention.

FIG. 2 is a schematic view of the present invention, wherein broken lines represent a remote system and solid lines represent an air-gapped device controller.

FIG. 3 is a perspective view of the present invention, wherein a keyboard and mouse controller of the air-gapped device controller is shown.

FIG. 4 is a perspective view of one embodiment of a stylus of the present invention.

FIG. 5 is a rear view of one embodiment of the stylus of the present invention.

FIG. 6 is a perspective view of the present invention, wherein a video exchange unit of the air-gapped device controller is shown.

FIG. 7 is a perspective view of the present invention, wherein an audio exchange unit of the air-gapped device controller is shown.

FIG. 8 is a top front perspective view of a protective casing, according to a preferred embodiment of the present invention.

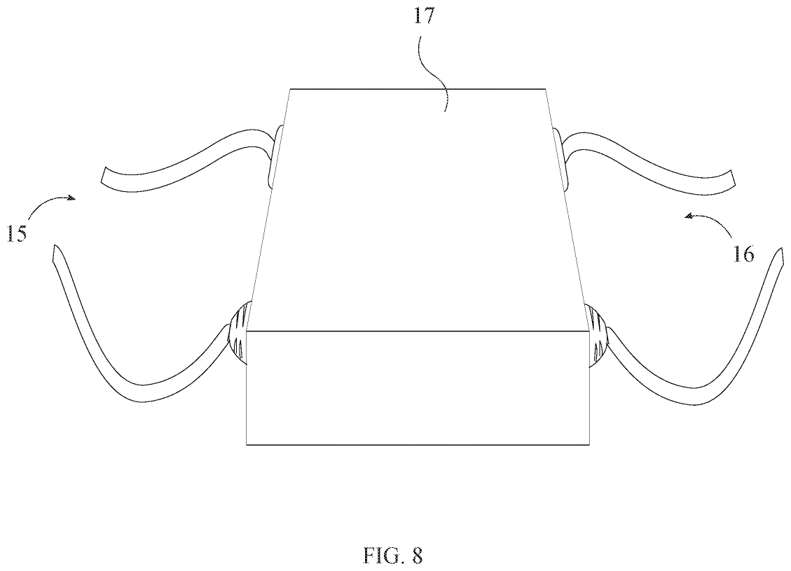

FIG. 9 is a top perspective view of the present invention, wherein an exploded view of the protective casing is shown.

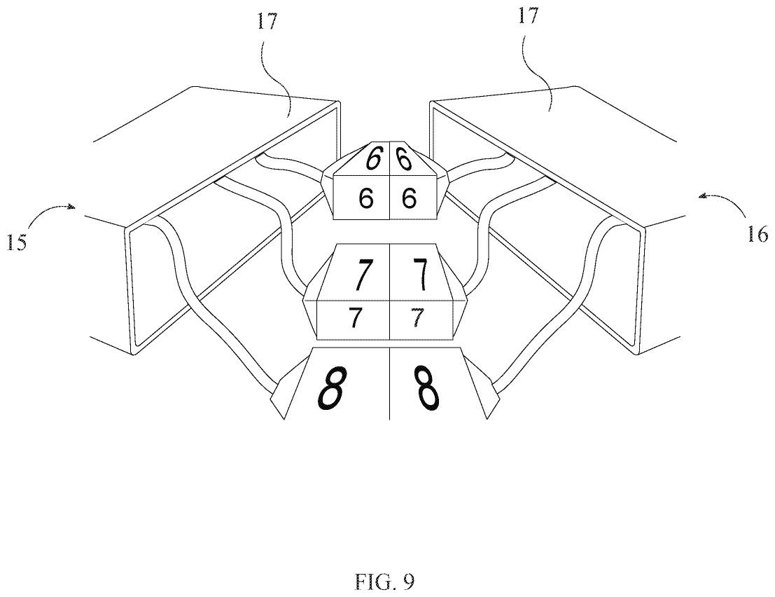

### DETAIL DESCRIPTIONS OF THE INVENTION

All illustrations of the drawings are for the purpose of describing selected versions of the present invention and are not intended to limit the scope of the present invention.

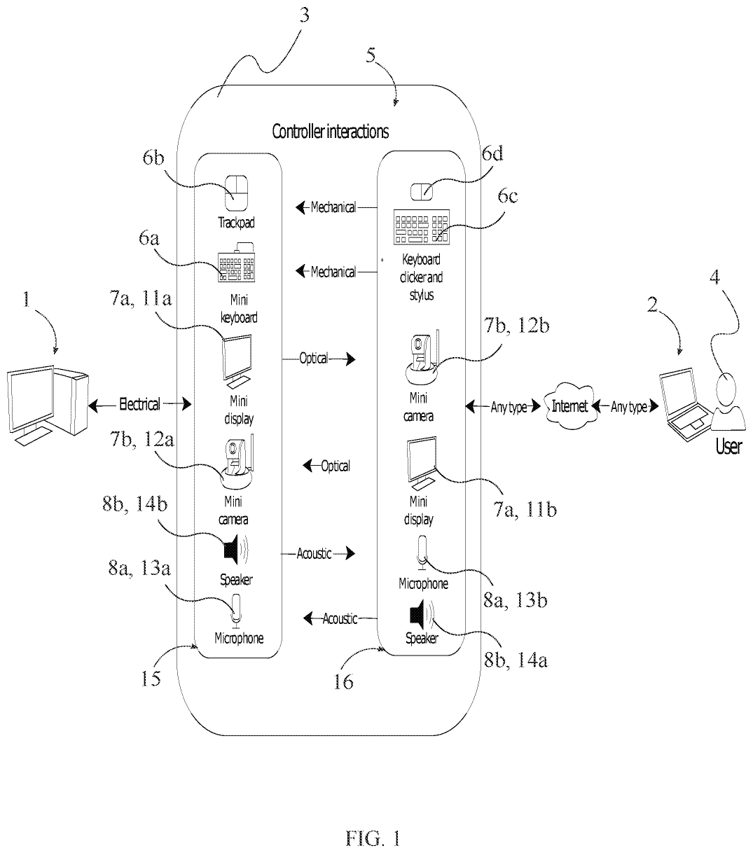

In reference to FIG. 1 through FIG. 7, the present invention is an air-gapped device controller. An objective of the present invention is to provide a disconnected (air-gapped) remote endpoint controller that does not allow any programmatic manipulation of the remote system and works exclusively on an analog basis. In other words, the present invention provides a system that allows the user to control an air gapped control system without physically operating the hardware of the air gap control system. To accomplish this, the present invention comprises an apparatus that is connected to the end-user via Internet or any other network and interacts with an air-gapped system (remote system) physically, it does so by translating the user's physical input to a signal on the wire and then recreating the user's physical input on the interface attached to the air-gapped system (e.g., pressing buttons, operating a touch pad or a mouse, user's video feed etc. Further, the present invention provides a method to allow the user to control an air gap control system without physically operating the hardware of the air gap control system. Additionally, the present invention can operate and control operating systems, computers, cameras, microphones, display systems, etc.

The present invention is the ONLY system that provides a COMPLETE air gap isolation without any signaling or emanations.

The following description is in reference to FIG. 1 through FIG. 7. According to a preferred embodiment, the present invention comprises a remote system 1, a user system 2, and an air-gapped device controller 3. Preferably, the remote system 1 and the user system 2 may be any operating system, such as a computer, a tablet, etc. In general, the remote system 1 and the user system 2 should have the same if not similar hardware, operating system, components, and of the likes. The present invention provides a method to allows a user 4 to control an airgap control system (the remote system 1) without physically operating the hardware of the air gap control system. The user system 2 is the hardware which the user has physical interaction with. The remote system 1 is the hardware which the user 4 controls by means of the air-gapped device controller 3. The remote system 1 is only accessible by physically being interacted with. To accomplish the smooth functioning of the present invention, the remote system 1 is electrically connected to the air-gapped device controller 3. This is because, the remote system 1 receives inputs from the air-gapped device controller 3 and convert them to outputs which mimic the interface and actions of the user system 1. Preferably, the remote system 1 may be connected to the air-gapped device controller 3 via a cable or any other physical or communicable connection. However, the air-gapped device controller 3 may be operated from any available computer-like device via a wired or a wireless connection over existing or specifically designed protocols and means of communication (Internet, optical, satellite etc.).

Furthermore, the user system 2 is operably coupled to the air-gapped device controller 3 through internet. In other words, the user may install the air-gapped device controller 3 into the network by means of hardwire, internet, software, or of the likes.

In order to effectively transfer and control different kinds of inputs between the user system 2 and the remote system 1, the air-gapped device controller 3 comprises a plurality of functional units 5. Preferably, the plurality of functional units 5 is communicably coupled between each other, wherein the plurality of functional units 5 facilitates mechanical, optical, and acoustic communication between the user system 2 and the remote system 1 through the air-gapped device controller 3. In other words, the present invention can operate and control operating systems, computers, cameras, microphones, display systems, etc., with the help of the plurality of functional units 5. However, the plurality of functional units 5 may comprise any other device, technology, operating system etc. that are known to one of ordinary skill in the art, as long as the intents of the present invention are not altered.

When connected, the user 4 is able to operate the user system 2 which will simultaneously operate the remote system 1. In addition, the remote system 1 will be displayed to the user 4 to allow them to see and observe their controls of the remote system 1 by means of the air gapped device controller 3. It is important to note that the present invention allows the user 4 to control a remote system 1 as if they were physically at the location controlling it. For example, if a computer at a work location contains confidential information, the user 4 must be physically there to control and operate the computer. However, with the present invention, the user 4 is able to control and operate the computer from a different location by using a different computer (user system 2) to control and operate the work computer (remote system 1). In other words, the user system 1 is operably coupled to the remote system 2 through the air-gapped device controller 3, wherein the air-gapped device controller 3 enables an emanation-less connectivity between the user system 1 and the remote system 2.

A more detailed description of the present invention follows. According to the preferred embodiment of the present invention, the plurality of functional units 5 comprises a keyboard and mouse controller 6, a video exchange unit 7, and an audio exchange unit 8. Preferably, the keyboard and mouse controller 6, transcribes and controls mechanical interactions between the remote system 1 and the user system 2. For example, if the user 4 had full control of a computer mouse on the user system 2, then the user 4 will also have the same full control of the computer mouse of the remote system 1. Similarly, the video exchange unit 7, transcribes and controls optical interactions between the remote system 1 and the user system 2. For example, the remote system 1 will be displayed to the user 4 to allow them to see and observe their controls of the remote system 2 by means of the video exchange unit 7. Similarly, the audio exchange unit 8, transcribes and controls acoustic interactions between the remote system 1 and the user system 2. For example, audio signals may be transmitted back and for the between the user system 2 and the remote system 1 with the help of the audio exchange unit 8.

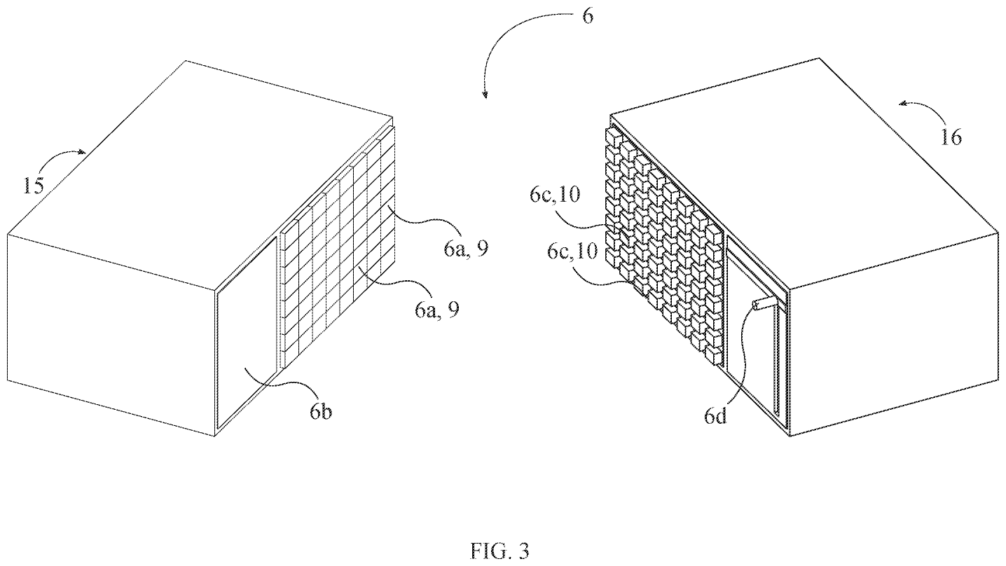

As seen in FIG. 1 and FIG. 3, the keyboard and mouse controller 6, comprises a keyboard 6a, a trackpad 6b, a keyboard clicker 6c and at least one stylus 6d. Preferably, the keyboard 6a and the trackpad 6b are electrically connected to the remote system 1, and the keyboard clicker 6c and the at least one stylus 6d are operably connected to the user system 2, wherein input from the user system 2 is transcribed to the keyboard 6a and the trackpad 6b. More specifically, the keyboard 6a is mechanically coupled to the keyboard clicker 6c, and the trackpad 6b is mechanically coupled to the at least one stylus 6d. In one embodiment, and as seen in FIG. 3, a plurality of keyboard keys 9 on the remote endpoint side may consist of simple electrical contact plates that represent most keys and key combinations in all computing standards, while the plurality of the key clickers 10 on the air-gapped device controller 3 could have a corresponding number of clickers that consist of metal contacts driven by some actuators, for example, piezo-electrical elements or stacks.

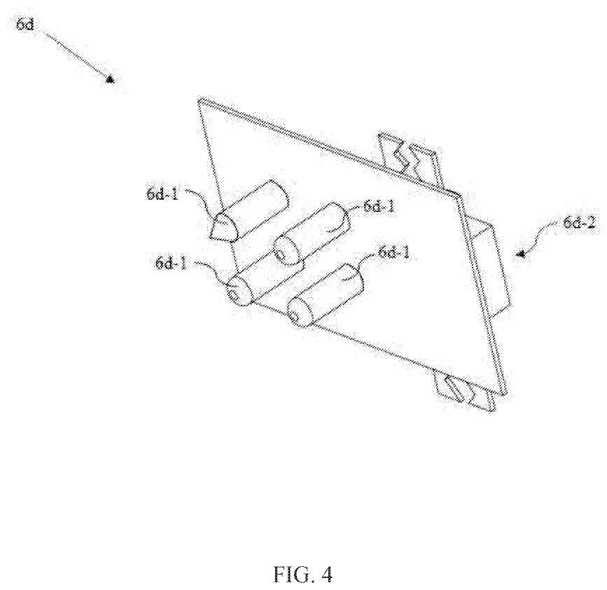

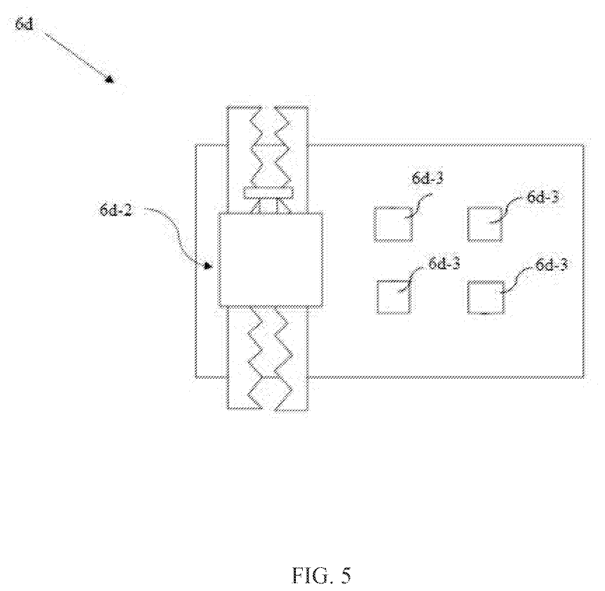

In another embodiment, as shown in FIGS. 4-5, the at least one stylus 6d may consist of a number of protruding pieces 6d-1 of plastic- or rubber-like cylinders with rounded or sharp points sufficient to imitate a single click, a double click, a one-finger click, a two-finger click, a three-finger click, a 4-finger click, and a drawing/writing point, all and any of them driven by a plurality of piezo-electrical actuators 6d-3 mounted on a 2-dimensional carriage, in turn, driven, for example, by servo actuators 6d-2.

In another embodiment, the trackpad 6b or mouse/drawing pad on the air-gapped device controller 3 side will allow for operation similar to that of a regular mouse and a regular stylus in all aspects of use.

As seen in FIG. 4, the video exchange unit 7 comprises a plurality of display devices 7a and a plurality of cameras 7b. Preferably, a first display device 11a and a first camera 12a are electrically connected to the remote system 1, and a second display device 11b and a second camera 12b are operably connected to the user system 2, wherein the first display device 11a and the second display device 11b are from the plurality of display devices 7a, and the first camera 12a and the second camera 12b are from the plurality of cameras 7b. Further, the first display device 11a is operably coupled to the second camera 12b, and the second display device 11b is operably coupled to the first camera 12a, wherein optical interactions between the user system 2 and the remote system 1 is facilitated by the plurality of display devices 7a and the plurality of cameras 7b.

In one embodiment, the plurality of display devices 7a on the controlled side (remote side 1) and a camera on the controller side (air-gapped device controller 3) will be enclosed in the dark environment and match each other's sizes exactly for the best quality and least interference from the outside and will allow viewing the controlled display by the controlling operator in the most optimal resolution and color presentation, while the same characteristics would apply to a reverse plurality of a display on the controller side and a camera on the controlled side.

As seen in FIG. 5, the audio exchange unit 8 comprises a plurality of microphones 8a and a plurality of speakers 8b. Preferably, a first microphone 13a and a first speaker 14a are electrically connected to the remote system 1, and a second microphone 13b and a second speaker 14b are operably connected to the user system 2, wherein the first microphone 13a and the second microphone 13b are from the plurality of microphones 8a, and the first speaker 14a and the second speaker 14b are from the plurality of speakers 8b. Further, the first microphone 13a is operably coupled to the second speaker 14b and the second microphone 13b is operably coupled to the first speaker 14a, wherein acoustic interactions between the user system 2 and the remote system 1 is facilitated by the plurality of microphones 8a and the plurality of speakers 8b.

In another embodiment, the plurality of speakers 8a on the controlled side and a microphone on the controller side will be enclosed in the sound-proof environment and match each other's output-input parameters exactly for the best quality and least interference from the outside and will allow listening to the controlled speaker by the controlling operator in the most optimal quality, while the same characteristics would apply to a reverse plurality of a speaker on the controller side and a microphone on the controlled side.

As seen in FIG. 1, the air gapped device controller 3 comprises a remote side unit 15 and a controller side unit 16. Preferably, the remote side unit 15 is physically coupled to the remote system 1, and the controller side unit 16 is operably connected to the user system 2, wherein input from the user system 2 is transferred as output from the remote system 1, thereby mimicking actions of the user system 2.

It is important to note that the present invention allows the user 4 to control remote system 1 as if they were physically at the location controlling it. For example, if a computer at a work location contains confidential information, the user 4 must be physically there to control and operate the computer. However, with the present invention, the user 4 is able to control and operate the computer from a different location by using a different computer (user system 2) to control and operate the work computer (remote system 1). More specifically, the remote side unit 15 interacts with the remote system 1 physically. The user input received through the controller side unit 16 is sent to the remote side unit 15 and converted into output of the remote system 1. In other words, the inputs of the user system 2 are mimicked onto the remote system 1 as outputs. Thus, recreating the user's physical input of the user system 2 onto the remote system 1. For example, if the user 4 had full control of a computer mouse on the user system 2, then the user 4 will also have the same full control of the computer mouse of the remote system 1. Preferably, the plurality of functional units 5 is evenly distributed between the remote side and the controller side.

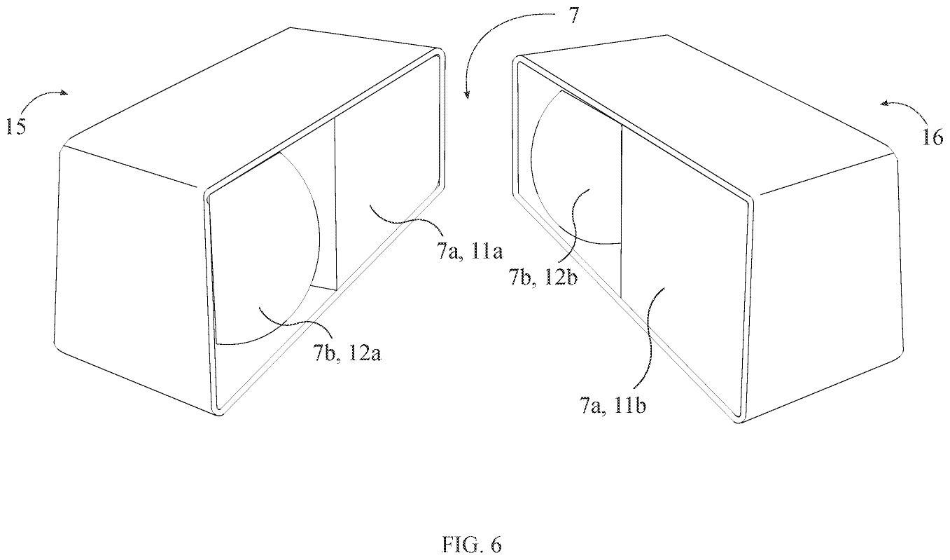

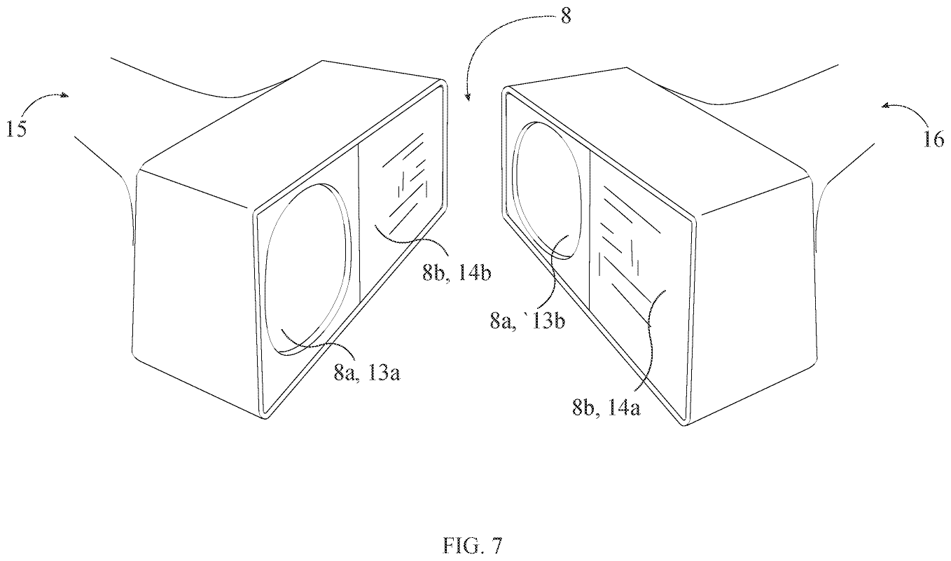

In reference to FIG. 6 and FIG. 7, the air-gapped device controller 3 comprises a protective housing 17. In other words, the air-gapped device controller 3 may include a protected housing 17 for connecting the remote side and the controlling side of the connection. This is so that, the electrical components and connections are safely secured, connected and protected from outside elements. More specifically, the remote side unit 15 and the controller side unit 16 are electrically coupled within the protective housing 17, as seen in FIG. 7.

The present invention provides a method to allow the user 4 to control an air gap control system 3 without physically operating the hardware of the air gap control system 3. Accordingly, the method includes entering a physical input to the user system 2 and recreating the physical input of the user system 2 onto the remote system 1 through the air-gapped device controller 3. Further, the method comprises receiving a sensory information from the remote system 1, transcribing the sensory information to an input signal, and sending the input signal into the user system 2 through the air-gapped device controller 3. In other words, the remote system 1 sends signals of sensory information and converts it to a signal is sent back and recreated on the user's interface of the controller system (user system 2), thereby resulting in real-time interaction with the remote system 2 by means of the controller system. Thus, the output of the remote system 1 is relayed back to the user system 2 to allow the user 4 to be aware of their controls real-time. For example, if the user is blind, haptic signals may be sent to the user system 2 from the remote system 1, with the help of keyboard sensors.

In a first alternate embodiment of the present invention, the user system 2 and the remote system 1 is at least one of an operating system, a computer, a tablet, a server, a console, and a terminal. In other words, a modular base assembly at the user endpoint may be set up, wherein the user system 2 is operably coupled to a plurality of air-gapped device controllers. Further, each of the plurality of air-gapped device controllers may be connected to one operating system, such as a computer, a tablet, a server etc. In this case, the plurality of air-gapped device controllers is electrically connected to each of the remote systems, and each of the plurality of air-gapped device controllers are connected to the modular user-endpoint system through the internet. However, the remote system 1 and the user system 2 may comprise any other computing and/or electrical systems, that are known to one of ordinary skill in the art, as long as the intents of the present invention are not altered.

In a second alternate embodiment of the present invention, the plurality of functional units 5 are miniature devices. For example, the remote side unit 15 may have a miniature keyboard, a miniature mousepad, a miniature display, a miniature video camera, a miniature speaker and a miniature microphone, while the controller side unit 16 may consist of a miniature keyboard presser, a miniature mouse and styluses, a miniature video camera, a miniature display, a miniature speaker and a miniature microphone corresponding to the opposite parts of the remote side.

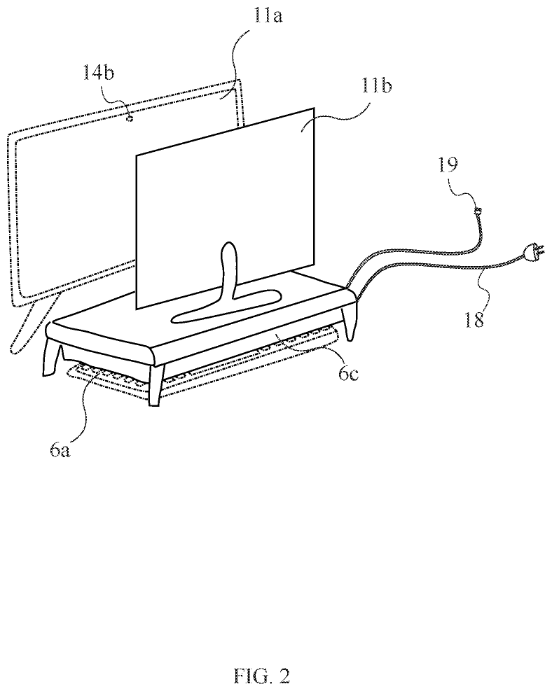

In reference to FIG. 2, the air-gapped device controller 3 may look like a “reverse laptop”, with operating parts corresponding to the inputs and outputs of the remote system 1: display to camera, camera to display, speaker to microphone, microphone to speaker, key clicker to keyboard, mouse to mouse pad, and stylus to writing/drawing pad. Further, as seen in FIG. 2, the present invention may comprise a power cable 18 and an ethernet cable 19, wherein the power cable 18 and the ethernet cable 19 are electrically connected to the air gap device controller 3.

In another embodiment, the analog controller input and output parts may correspond to an IoT device input/output parts or any other device that has an analog input avenue.

In most embodiments, the air-gapped device controller 3 can be operated by a user system from any available computer-like device via a wired or a wireless connection over existing or specifically designed protocols and means of communication (Internet, optical, satellite etc.).

In another embodiment, the air-gapped device controller 3 may have as small form factor as technically possible with a plurality of miniature or even microscopic parts.

In another embodiment, the plurality of functional units 5 may have a regular size form factor to provide the cheapest solution.

Although the invention has been explained in relation to its preferred embodiment, it is to be understood that many other possible modifications and variations can be made without departing from the spirit and scope of the invention as hereinafter claimed.

What is claimed is:

1. An air-gapped device controller system comprising:
a remote system;
a user system;
an air-gapped device controller;
the air-gapped device controller comprising a plurality of functional units;
the remote system being electrically connected to the air-gapped device controller;
the user system being operably coupled to the air-gapped device controller through internet;
the plurality of functional units being communicably coupled between each other, wherein the plurality of functional units facilitates mechanical, optical, and acoustic communication between the user system and the remote system through the air-gapped device controller; and
the user system being operably coupled to the remote system through the air-gapped device controller, wherein the air-gapped device controller enabling an emanation-less connectivity between the user system and the remote system.

2. The air-gapped device controller system of claim 1, the plurality of functional units comprising:
a keyboard and mouse controller;
a video exchange unit;
an audio exchange unit;
the keyboard and mouse controller transcribing and controlling mechanical interactions between the remote system and the user system;
the video exchange unit transcribing and controlling optical interactions between the remote system and the user system; and
the audio exchange unit transcribing and controlling acoustic interactions between the remote system and the user system.

3. The air-gapped device controller system of claim 2, wherein:
the keyboard and mouse controller comprising a keyboard, a trackpad, a keyboard clicker and at least one stylus;
the keyboard and the trackpad being electrically connected to the remote system;
the keyboard clicker and the at least one stylus being operably connected to the user system, wherein input from the user system is transcribed to the keyboard and the trackpad;
the keyboard being mechanically coupled to the keyboard clicker; and
the trackpad being mechanically coupled to the at least one stylus.

4. The air-gapped device controller system of claim 2, wherein:
the video exchange unit comprising a plurality of display devices and a plurality of cameras;
a first display device and a first camera being electrically connected to the remote system;
a second display device and a second camera being operably connected to the user system, wherein the first display device and the second display device are from the plurality of display devices, and the first camera and the second camera are from the plurality of cameras; and
the first display devices being operably coupled to the second camera, and the second display device being operably coupled to the first camera, wherein optical interactions between the user system and the remote system is facilitated by the plurality of display devices and the plurality of cameras.

5. The air-gapped device controller system of claim 2, wherein:
the audio exchange unit comprising a plurality of microphones and a plurality of speakers;
a first microphone and a first speaker being electrically connected to the remote system;
a second microphone and a second speaker being operably connected to the user system, wherein the first microphone and the second microphone are from the plurality of microphones and the first speaker and the second speaker are from the plurality of speakers; and
the first microphone being operably coupled to the second speaker and the second microphone being operably coupled to the first speaker, wherein acoustic interactions between the user system and the remote system is facilitated by the plurality of microphones and the plurality of speakers.

6. The air-gapped device controller system of claim 1, the air gapped device controller comprising:
a remote side unit and a controller side unit;
the remote side unit being physically coupled to the remote system; and
the controller side unit being operably connected to the user system, wherein input from the user system being transferred as output from the remote system, thereby mimicking actions of the user system;

7. The air-gapped device controller system of claim 6, comprising:
a protective housing;
the plurality of functional units being evenly distributed between the remote side and the controller side; and
the remote side unit and the controller side unit being electrically coupled within the protective housing.

8. The air gapped device controller system of claim 1, wherein the air-gapped device controller being configured to:
enter a physical input to the user system; and
recreate the physical input of the user system onto the remote system through the air-gapped device controller.

9. The air gapped device controller system of claim 1, wherein the air-gapped device controller being configured to:
receive a sensory information from the remote system;
transcribe the sensory information to an input signal; and
send the input signal into the user system through the air-gapped device controller.

10. The air-gapped device controller system of claim 1, wherein the user endpoint device and the remote endpoint device is at least one of an operating system, a computer, a tablet, a server, a console, and a terminal.

11. The air-gapped device controller system of claim 1, wherein the plurality of functional units are miniature devices.

12. The air-gapped device controller system of claim 1, comprising:
a power cable and an ethernet cable; and
the power cable and the ethernet cable being electrically connected to the air-gapped device controller.

13. An air-gapped device controller system comprising:
a remote system;
a user system;
an air-gapped device controller;
the air-gapped device controller comprising a keyboard and mouse controller, a video exchange unit, an audio exchange unit;
the remote side unit being physically coupled to the remote system;
the controller side unit being operably connected to the user system, wherein input from the user system being transferred as output from the remote system, thereby mimicking actions of the user system;
the remote system being electrically connected to the air-gapped device controller;
the user system being operably coupled to the air-gapped device controller through internet;
the keyboard and mouse controller transcribing and controlling mechanical interactions between the remote system and the user system;
the video exchange unit transcribing and controlling optical interactions between the remote system and the user system;
the audio exchange unit transcribing and controlling acoustic interactions between the remote system and the user system; and
the user system being operably coupled to the remote system through the air-gapped device controller, wherein the air-gapped device controller enabling an emanation-less connectivity between the user system and the remote system.

14. The air-gapped device controller system of claim 13, wherein:
the air-gapped device controller comprising a remote side unit and a controller side unit;
the remote side unit being physically coupled to the remote system;
the controller side unit being operably connected to the user system, wherein input from the user system being transferred as output from the remote system, thereby mimicking actions of the user system;
the keyboard and mouse controller comprising a keyboard, a trackpad, a keyboard clicker and at least one stylus;
the video exchange unit comprising a plurality of display devices and a plurality of cameras; and
the audio exchange unit comprising a plurality of microphones and a plurality of speakers.

15. The air-gapped device controller system of claim 14, wherein:
the keyboard and the trackpad being electrically connected to the remote side unit;
the keyboard clicker and the at least one stylus being operably connected to the controller side unit;
the keyboard being mechanically coupled to the keyboard clicker; and
the trackpad being mechanically coupled to the at least one stylus.

16. The air-gapped device controller system of claim 14, wherein:
a first display device and a first camera being electrically connected to the remote side unit;
a second display device and a second camera being operably connected to the controller side unit, wherein the first display device and the second display device are from the plurality of display devices, and the first camera and the second camera are from the plurality of cameras;
the first display devices being operably coupled to the second camera, and the second display device being operably coupled to the first camera, wherein optical interactions between the user system and the remote system is facilitated by the plurality of display devices and the plurality of cameras.

17. The air-gapped device controller system of claim 14, wherein:
a first microphone and a first speaker being electrically connected to the remote side unit;
a second microphone and a second speaker being operably connected to the controller side unit, wherein the first microphone and the second microphone are from the plurality of microphones and the first speaker and the second speaker are from the plurality of speakers;
the first microphone being operably coupled to the second speaker and the second microphone being operably coupled to the first speaker, wherein acoustic interactions between the user system and the remote system is facilitated by the plurality of microphones and the plurality of speakers.

18. The air-gapped device controller system of claim 14, comprising:
a protective housing; and
the remote side unit and the controller side unit being electrically coupled within the protective housing.

19. The air gapped device controller system of claim 13, wherein the air-gapped device controller being configured to:
enter a physical input to the user system; and
recreate the physical input of the user system onto the remote system through the air-gapped device controller.

20. The air gapped device controller system of claim 13, wherein the air-gapped device controller being configured to:
receive a sensory information from the remote system;
transcribe the sensory information to an input signal; and
send the input signal into the user system through the air-gapped device controller.
